(19) United States
(12) Patent Application Publication
(10) Pub. No.: US 2007/0028750 A1
(43) Pub. Date: Feb. 8, 2007

(54) Apparatus, system, and method for real-time collaboration over a data network

(76) Inventors: Thomas E. Darcie, Victoria (CA); John E. Golub, Jerusalem (IL); Peter E. Driessen, Sydney (CA)

Correspondence Address: John E. Golub, Nave Shaanan 2, Jerusalem, 93707, IL

(21) Appl. No.: 11/491,888

(22) Filed: Oct. 6, 2006

Related U.S. Application Data
(60) Provisional application No. 60/705,980, filed on Aug. 5, 2005.

(51) Int. Cl. G10H 1/08; G10H 7/00

(52) U.S. Cl. 84/625

(57) ABSTRACT

The present invention enables music performers and sound engineers to perform collaboratively over a data network such as the internet. Each musician creates musical signals which are processed at two points: Signals are processed at a central server to produce a mix, which mix is subsequently distributed to all participants; Signals are additionally processed at each musician's location whereby each musician's track is removed from the mix and replaced with a local, low-latency version of said musician's track. In this way, musicians play to a real-time mix that satisfies the strict requirements for low delay. Using records of each musician's tracks kept at the server, musicians or sound engineers can post-process the tracks to create one or more master mixes in which delays are eliminated entirely and tracks are synchronized.

### PRIORITY

This application claims priority from U.S. Provisional Application 60/705,98 dated Aug. 5, 2005.

### TECHNICAL FIELD

The present version of the invention relates generally to data networking in general, and more specifically to a data networks that enable remote, real-time collaboration in particular.

### BACKGROUND

The internet has increased productivity and facilitated interpersonal communications through services like electronic mail, communities of interest, and others. All these services rely on file transfer in one form or another.

One important trend in internet evolution is the penetration of broadband (high-speed) internet access. Over eleven percent (11%) of Americans have broadband access to the internet in their homes according to PricewaterhouseCoopers. PricewaterhouseCoopers further estimate that fifty percent (50%) of Americans will be broadband enabled in the home by 2008.

A second important trend in internet evolution is the growth in broadband service offering. Services such as streaming media already rely on high-speed connectivity. Also, television service is being offered or will be offered over internet infrastructure. These services are distinguished from file transfer services because of the requirement for continuity of service at the receiving end.

A third trend in internet evolution is the trend toward real-time interactions between users. Real-time interactions are distinguished from file-transfer by a tight requirement for low propagation delay and other quality-of-service metrics in the internet. Internet-based telephony (also called Voice-Over-internet-Protocol or VoIP) is an example of a service that enables near-real-time interaction between users. Real-time services are distinguished from file transfer and from streaming media services by the strict requirement for low delay and high quality-of-service in the internetworking of a number of remote users.

According to a 2003 survey commissioned by the National Association of Music Merchants and conducted by the Gallup Organization, 54% of American households have a member who plays a musical instrument. The US Census Bureau estimates there are 127,000,000 households in the United States as of 2004, so we may estimate that over 68,500,000 of these are musical households.

Many musicians play in groups such as school bands, garage bands, ensembles, choral groups, etc. For many musicians, group performance enriches the musical experience and adds a new dimension to their playing. Many other musicians desire to play in groups—or desire to play in groups more frequently—but do not do so because of certain barriers. These barriers include the need to coordinate schedules with group members; the need to travel to meet group members; access to specialized equipment; and want of suitable partners or group members.

Many students of music receive music lessons from music teachers and many others could receive lessons but for certain barriers. These barriers include the need to coordinate schedules between student and teacher; the need for one party to travel to meet the other; want of sufficient or suitable teachers or students; and cost.

Many musicians are professionals, semi-professionals, or high-end amateurs who desire to record music of sufficient quality for publication or distribution. These musicians require significant functionality related to sound engineering. Sound engineering may be implemented using, e.g., a mixer board device and, possibly, other electronic instruments. Sound engineering may be required during the performance of the music or afterwards, or both. In addition, a group member may wish to play or listen to an original track while recording their own track synchronizing their play and track recording to the original track.

Many musicians desire to play music in collaboration with previously recorded music. For example, a singer may add a voice track to a previously recorded instrumental piece. Or a group member may wish to revise his performance without affecting tracks recorded by other group members.

In the broadest sense, musicians desire to perform music with other musicians and, possibly, one or more sound engineers using sound equipment to condition and record the music and to further process the music after recording. Henceforth, we will call this process “collaborative music making” and refer to each participant—whether performer, teacher, student, or sound engineer—as a “musician” or “participant”. Also, by “performer” we understand players of instruments in the broadest sense including all traditional instruments, electronic instruments whether digital or analog, the human voice, and any other.

In collaborative music making, it is common for each performer to produce a music signal that is delivered to an audio mixer device. The mixer device combines the separate music signals from the various performers to create a so-called mix. The mix is then distributed to headsets that the performers wear or to monitor speakers close to the particular performer. Thus, as the performers play, they receive audio feedback from themselves and the other performers. Also commonly, the various audio signals from the various musicians are recorded. These recorded signals may then be remixed at a later time. A final mix, used for reproduction, publication, or distribution purposes, is called the master mix.

Also commonly, different musicians may receive from the mixer different mixes, each mix optimized for the particular performer's needs or preferences. For example in a rock group, a bass guitarist may prefer a mix that emphasizes the drums while a singer may prefer a mix than emphasizes the lead guitarist.

Also commonly, a performer may produce more than one music signal as, for example, when a guitarist also sings. Music signals may be analog, digital, or encoded in some other way such as through the Musical Instrument Digital Interface (MIDI) standard.

Due to the studio architecture described above, there is a slight time delay between the moment at which a performer creates music and the time at which that music arrives at the performer's ear via his headset. This time delay will, henceforth, be called the “self delay.”

Also due to the studio architecture described above, there are slight delays between the moment at which a performer creates music and the times at which that music arrives at the other performers' ears via their headsets. These time delays will, henceforth, be called the “inter-performer delays. Self and inter-performer delays will, henceforth, be called the “Delays.”

Those of skill in the sound engineering art understand that there are important upper limits on the amount of self delay and inter-performer delays that can be tolerated in the mix. These requirements derive from the need to give performers audio feedback of sufficient quality as to allow them to perform their music optimally. The self-delay should be as small as possible but in any event, should not exceed ten (10) milliseconds. Although this figure does not represent a hard cutoff, it is known that self-delays significantly beyond ten (10) milliseconds may cause the musician to become disoriented and perform badly. The inter-performer delay should be as small as possible but in any event, should not exceed fifty (50) milliseconds. Although this figure does not represent a hard cutoff, it is known that self-delays significantly beyond fifty (50) milliseconds may cause the musician to become disoriented and perform badly.

Those of skill in the sound engineering art understand that there are different requirements on the synchronism between the different music signals that can be tolerated in the master mix. These requirements derive from the desire to achieve the highest audio quality in the final, master mix. In particular, the sound engineer will commonly adjust the master mix so as to synchronize the different music signals as much as possible.

Attempts to use the internet to interconnect remotely located musicians and enable them to engage in collaborative music making encounter a number of barriers. First, because the internet is a best-effort data network with significant, variable delay, it is apparently poorly suited to collaborative music making because of the requirements on time delays described above. Also, because of the finite data rates available to many home users, delivery of music signals over the internet often involves signal processing techniques such as audio compression, which techniques can degrade music quality and add delay as side-effects. For the above stated reasons the internet is unable to deliver self delay and inter-performer delays that are acceptable to a musician wishing to participate in a real-time interaction with other remotely located musicians.

Therefore, for the foregoing reasons, it is readily apparent that there is a need for an apparatus, system and method for collaborative music mediated by a data network such as the internet possibly in combination with a proprietary low latency network. More specifically, there is a need for an apparatus and method to permit remotely-located musicians to perform together while each receives a high-quality mix, to record the music as it is performed, and to perform sound engineering functions both during the performance and afterwards.

Briefly described, in the preferred embodiment, the present version of the invention overcomes the above-mentioned disadvantages and meets the recognized need for such a device by providing an apparatus, system and method for collaborative music that permit remotely-located musicians to perform together without delays that exceed specified limits of self delay and/or inter-performer delays.

According to its major aspects and broadly stated, the present version of the invention in its preferred form is an apparatus, system and method to permit collaborative music making by remotely located musicians.

More specifically, the preferred embodiment of the present version of the invention discloses a hardware, software, and a data network architecture which implements a distributed sound studio. Musicians connect to a server using a high-speed internet access line. Once connected, music signals are backhauled by the data network to the server where they may be recorded and where sound engineering functions are carried out. Musicians control the sound engineering remotely through, e.g., a web interface such as a web browser. One or more mixes generated by the server are then distributed over the network to a signal processing device in the user's studio. Using digital signal processing techniques, the signal processing device removes the musicians own track(s) from the mix and replaces same with versions of the musicians own track(s) that have not been transported over the data network. In this way, each musician receives a mix with very low self-delay, while, at the same time, the bandwidth required at the mixer output is minimized.

Accordingly, a feature and advantage of the present version of the invention is its ability to provide a system and method for remote, collaborative performance of music with low self delay.

Another feature and advantage of the present version of the invention is its ability to provide a system and method for remote, collaborative performance of music with reduced bandwidth requirement.

Another feature and advantage of the present version of the invention is its ability to provide a system and method for remote, collaborative performance of music with low inter-performer delay.

Still another feature and advantage of the present version of the invention is its ability to provide a system and method for remote, collaborative performance of music with self delay that is not increased by the intentional addition of latency.

Yet another feature and advantage of the present version of the invention is its ability to provide a system and method for remote, collaborative performance of music between two or more musicians.

Still yet another feature and advantage of the present version of the invention is its ability to provide a system and method for remote, collaborative performance of music between two or more musicians and a pre-recorded streaming music track.

Still yet another feature and advantage of the present version of the invention is its ability to provide a system and method for remote, collaborative performance of music such that a high-fidelity record of the collaborative performance is produced.

Still yet another feature and advantage of the present version of the invention is its ability to provide a system and method for remote, collaborative performance of music with such that a highly synchronized record of the collaborative performance is produced.

Still yet another feature and advantage of the present version of the invention is its ability to provide a system and method for the publication and offering for sale or licensing of musical recordings, files, and/or related intellectual property rights.

Still yet another feature and advantage of the present version of the invention is its ability to provide a system and method for the simultaneous remote, collaborative performance of music between a plurality of individual musicians and a musician.

These and other features and advantages of the present version of the invention will become more apparent to one skilled in the art from the following description and claims when read in light of the accompanying drawings.

### BRIEF DESCRIPTION OF THE DRAWINGS

The present version of the invention will be better understood by reading the Detailed Description of the Preferred and Alternate Embodiments with reference to the accompanying drawing figures, in which like reference numerals denote similar structure and refer to like elements throughout, and in which:

FIG. 1 is a high-level system architecture;

FIG. 2 is a block diagram of the user subsystem;

FIG. 3 is a block diagram of the server subsystem;

FIG. 4 is a block diagram of the preferred embodiment of the signal processing block 210 of the user subsystem 200; and

FIG. 5 is a block diagram of the preferred embodiment of the signal processing block 530 of the server subsystem 500.

### DETAILED DESCRIPTION OF THE PREFERRED AND ALTERNATIVE EMBODIMENTS

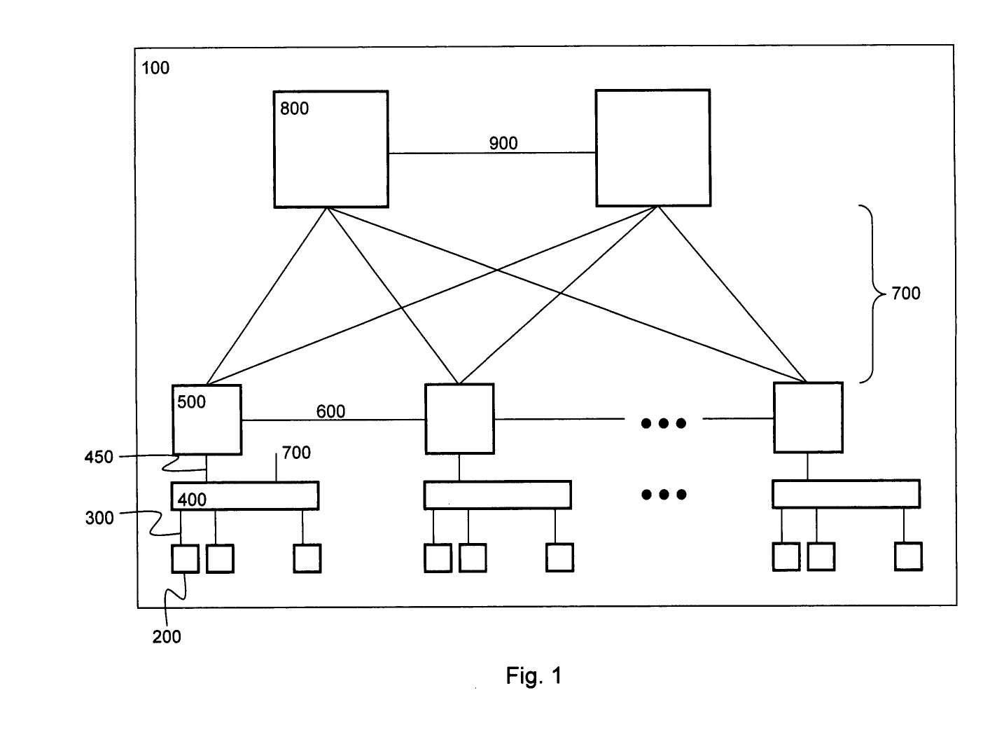

In describing the preferred and alternate embodiments of the present version of the invention, as illustrated in FIGS. 1-5, specific terminology is employed for the sake of clarity. The present version of the invention, however, is not intended to be limited to the specific terminology so selected, and it is to be understood that each specific element includes all technical equivalents that operate in a similar manner to accomplish similar functions.

Referring now to FIGS. 1-5, the present version of the invention in its preferred embodiment is

Referring now to FIG. 1, there is illustrated a preferred system 100 comprising user subsystems 200; access lines 300; access networks 400; interoffice links 450; regional servers 500; backbone network 600; internet 700; central servers 800; and data network 900. In this and the following, certain illustrative numbers of each of these elements are shown for convenience. However, one of ordinary skill in the art understands that the present invention applies equally well to any number of these components.

User subsystem 200 is preferably capable of a number of functions. Specifically, user subsystem 200 is capable of receiving audio inputs of various formats from a user. Also, user subsystem 200 is capable of transmitting digitally-encoded audio signals to a regional server 500 via a data network such as the internet. Also, user subsystem 200 is capable of receiving digitally-encoded audio signals from a regional server 500 via a data network such as the internet. Also, user subsystem 200 is capable of performing certain signal processing functions on said audio signals received from a user and/or from a regional server. Also, user subsystem 200 is capable of exchanging information with a central server 800. Also, user subsystem 200 is capable of storing information including digital records of audio information. Also, user subsystem 200 is capable of initiating certain network diagnostic tests such as tests for latency.

Regional server 500 is preferably capable of a number of functions. Specifically, regional server 500 is capable of transmitting and receiving audio signals to user subsystems 200. Also, regional server 500 is capable of performing certain signal processing functions on audio signals received from user subsystems 200. Also, regional server 500 is capable of performing certain signal processing functions on audio signals to be transmitted to user subsystems 200. Also, regional server 500 is capable of performing certain sound engineering functions on audio signals such as mixing multiple signals together to form a new mix. Also, regional server 500 is capable of storing information including digital records of audio information.

Central server 800 is preferably capable of a number of functions. Specifically, central server 800 is capable of communicating with user subsystems 200 using, e.g., a web browser. Also, central server 800 is capable of admitting users and keeping track of authorized users. Also, central server 800 is capable of requesting and storing user data such as personal data, preference data, billing data, etc. Also, central server 800 is capable of exchanging information with regional servers 500. Also, server 800 is capable of interacting with users in remote studios to initiate, regulate, and manage collaborative music sessions through, e.g., a graphical user interface accessible on an internet web site.

To operate system 100, a musician first points his browser at the server web site where he registers, logs in, or otherwise initiates a session. Once a music session has been initiated, one or more musicians in a first remote studio perform music which music is input to a first user subsystem 200. Music data from the user subsystem 200 is then transmitted over the access line 300, access network 400, and interoffice link 450 to the regional server 500. Optionally, a high-fidelity record of said music data is stored at said first user subsystem 200 for subsequent processing and/or transmission to regional server 500. At the same time, one or more musicians in a second remote studio perform music that is input to a second user subsystem 200. Music data from their remote studio is also transmitted over the access line 300, access network 400, and interoffice link 450 to the regional server 500. Also optionally, a high-fidelity record of said music data may be stored at said second user subsystem 200 for subsequent processing and/or transmission to regional server 500. At regional server 500, music data from the remote studios is processed to form a mix, which mix is then transmitted over the data network to both remote studios. At the first remote studio, music data corresponding to the audio signals produced by the one or more users at the first remote studio are removed from the mix using the signal processing capabilities of the first user subsystem 200. Thereafter, a local version of the music data corresponding to the audio signals produced by the one or more users at the first remote studio is added to the mix using the signal processing capabilities of the first user subsystem 200. Finally, the resulting mix is delivered to an output port of the user subsystem 200 and to a listening device such as a headset or loudspeaker.

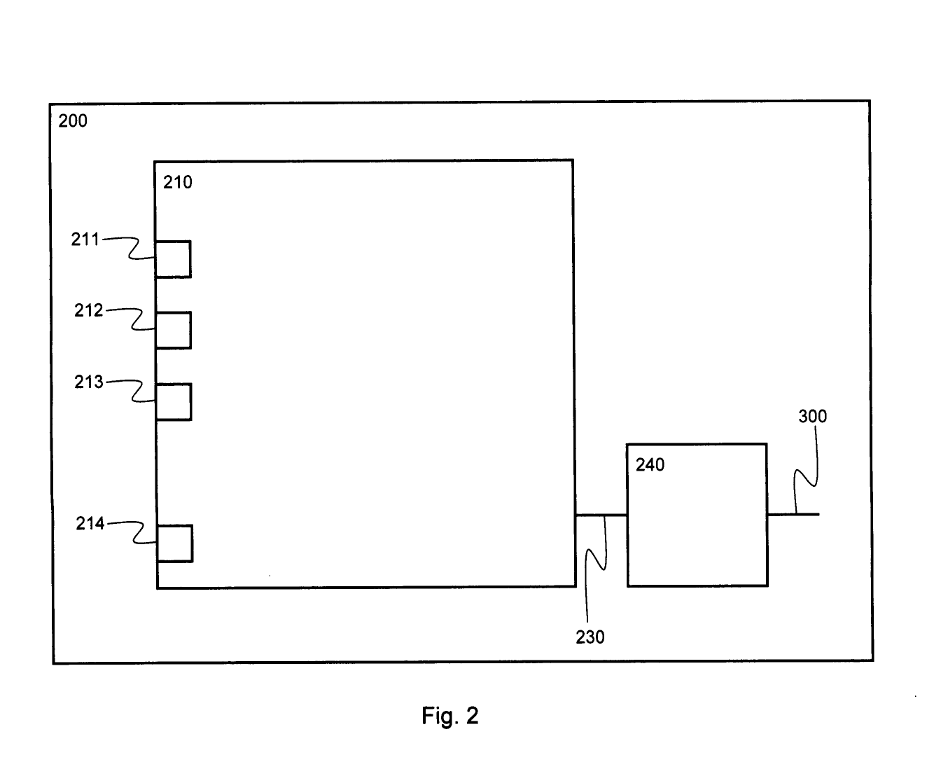

Referring now to FIG. 2, there is illustrated a preferred user subsystem 200 comprising signal processing block 200; connection 230; network interface device 240; and the termination of access line 300.

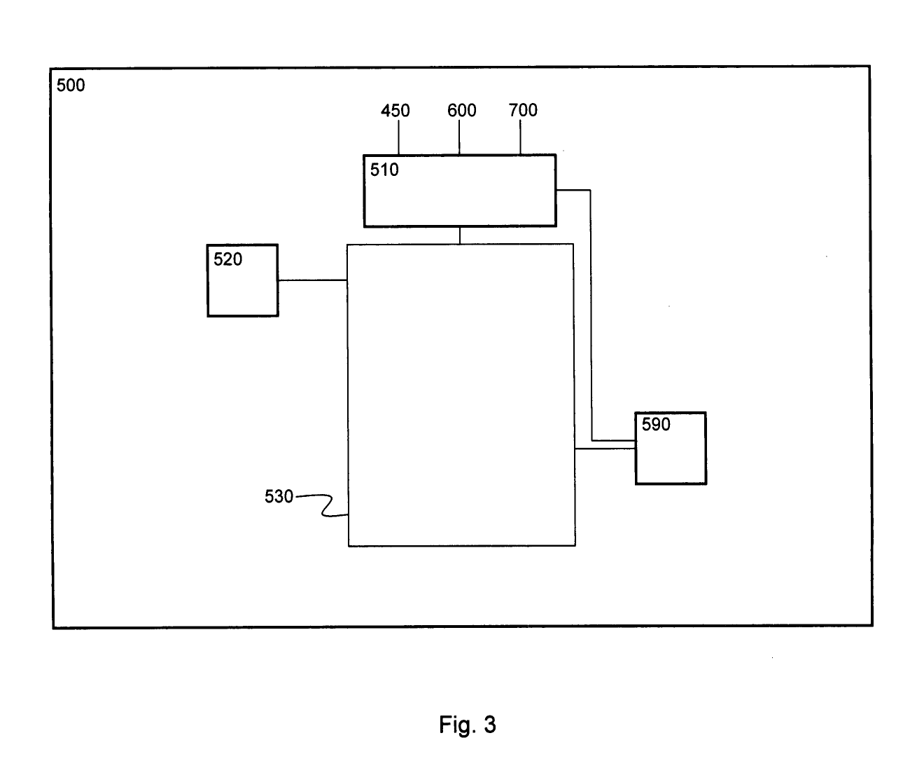

Referring now to FIG. 3, there is illustrated a preferred regional server 500 comprising network interface device 510; storage device 520; signal processing block 530; and information manager 590.

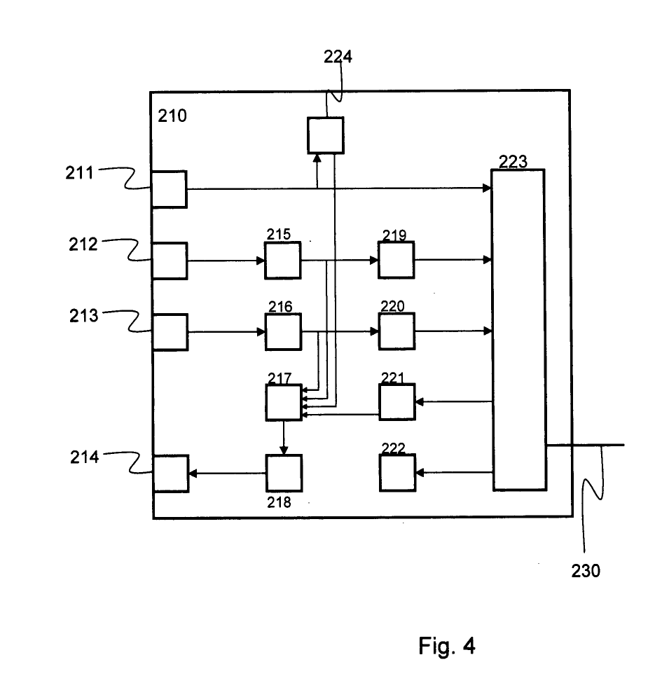

Referring now to FIG. 4, there is illustrated a preferred signal processing block 210 comprising input port 211 for Musical Instrument Digital Interface (MIDI) data; input port 212 for analog musical data; input port 213 for voice data; output port 214 for the mix; block 215 for analog-to-digital conversion; block 216 also for analog-to-digital conversion; block 217 for digital signal processing functions such as but not limited to track cancellation and track addition; block 218 for digital-to-analog conversion; block 224 for MIDI-to-digital conversion; block 219 for digital signal processing functions such as but not limited to data compression or encoding; block 220 for digital signal processing functions such as but not limited to data compression or encoding; block 221 for digital signal processing functions such as but not limited to data decompression or decoding; block 222 for performance monitoring and diagnostics functions; and network interface block 223.

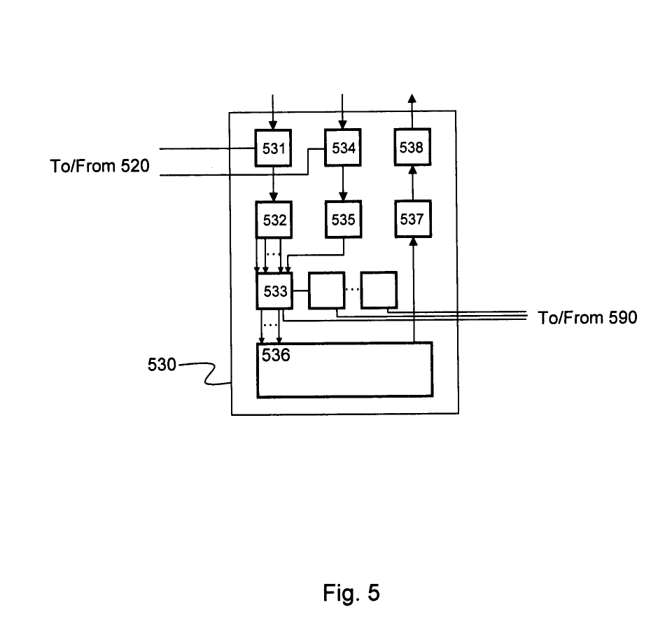

Referring now to FIG. 5, there is illustrated a preferred signal processing block 530 comprising blocks 531 and 534, each for separating data streams coded in a data protocol such as Internet Protocol or another data protocol into separate streams of music data; blocks 532 and 535, each for performing certain digital signal processing functions such as but not limited to data decompression or decoding; blocks 533, each for performing certain sound engineering functions such as but not limited to mixing; communications bus 536; block 537 for performing certain digital signal processing functions such as but not limited to data compression or encoding; and block 538 for combining streams of music data into a data protocol such as Internet Protocol or another data protocol.

Having thus described exemplary embodiments of the present version of the invention, it should be noted by those skilled in the art that the within disclosures are exemplary only, and that various other alternatives, adaptations, and modifications may be made within the scope of the present version of the invention. Accordingly, the present version of the invention is not limited to the specific embodiments illustrated herein, but is limited only by the following claims.

1. A method for facilitating real-time collaborative music between musicians, the method comprising the steps of:
(a) receiving a performance input from a first musician;
(b) receiving a performance input from a second musician;
(c) mixing said first performance with said second performance;
(d) transmitting said mixed performance to said first musician; and
(e) transmitting said mixed performance to said second musician.

2. A method for facilitating real-time collaborative music between musicians, the method comprising the steps of:
(a) receiving a performance input from a first musician;
(b) receiving a performance input from a second musician;
(c) mixing said first performance with said second performance;
(d) transmitting said mixed performance to said first musician's location;
(e) processing said mixed performance together with said performance input from said first musician;
(f) delivering said first processed mixed performance to said first musician;
(g) transmitting said mixed performance to said second musician's location;
(h) processing said mixed performance together with said performance input from said second musician;
(i) delivering said second processed mixed performance to said second musician.

3. An apparatus for receiving and transmitting real time signals at a source over a communications network, the apparatus comprising:
(a) means for transmitting a real time signal from a local source to a server in said communications network;
(b) means for receiving a real time mixed signal from said server in said communications network from at least one other remote source;
(c) means for canceling said local source signal from said mixed signal at said source; and
(d) means for inputting said local source in said mixed signal.
